(19) United States
(12) Patent Application Publication
(10) Pub. No.: US 2014/0078003 A1
(43) Pub. Date: Mar. 20, 2014

(54) ANTENNA MODULE AND WIRELESS COMMUNICATION DEVICE

(71) Applicant: Chiun Mai Communication Systems, Inc., New Taipei (TW)

(72) Inventors: TE-CHANG LIN, New Taipei (TW); CHO-KANG HSU, New Taipei (TW)

(73) Assignee: CHIUN MAI COMMUNICATION SYSTEMS, INC., New Taipei (TW)

(21) Appl. No.: 14/017,427

(22) Filed: Sep. 4, 2013

(30) Foreign Application Priority Data
Sep. 18, 2012 (TW) 101134072

(51) Int. Cl. H01Q 5/00

(52) U.S. Cl. CPC H01Q 5/0027
USPC 343/700 MS

(57) ABSTRACT

An antenna module for a wireless communication device includes a first ground portion for grounding to the antenna module, a feed portion, a connecting portion connected to the first ground portion and the feed portion, a first radiating body, a second radiating body connected to the feed portion and the first radiating body, a second ground portion, and an extending portion connected to the second ground portion and spaced from the feed portion. The first radiating body operates within a first working frequency band. The second radiating body operates within a second working frequency band. The second ground portion, the feed portion, and the first ground portion are parallel to and spaced from each other. The extending portion is configured to adjust a bandwidth of a preset frequency band of the antenna module.

### BACKGROUND

1. Technical Field

The disclosure generally relates to wireless communication devices, and particularly to a wireless communication device having an integrated metal appearance and a better radiating performance.

2. Description of Related Art

With the developments of wireless communication and information processing technologies, wireless communication devices such as mobile phones and personal digital assistants are now in widespread use. Users can transmit and receive electromagnetic waves via antennas mounted in the wireless communication devices.

To realize the wireless communication devices suitable for different communication systems, wideband antennas are used to allow transmission and reception of multiple frequency bands for different communication systems. However, many wideband antennas have complicated structures and large sizes, making it difficult to miniaturize portable electronic devices. Even if some miniaturized antennas can be installed in the portable electronic devices, precise installation is difficult

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a schematic view of a wireless communication device having an antenna module, according to a first exemplary embodiment of the disclosure.

FIG. 2 is similar to FIG. 1, but shown from another aspect.

FIG. 3 is a diagram showing return loss (RL) measurements of the antenna module of FIG. 1.

### DETAILED DESCRIPTION

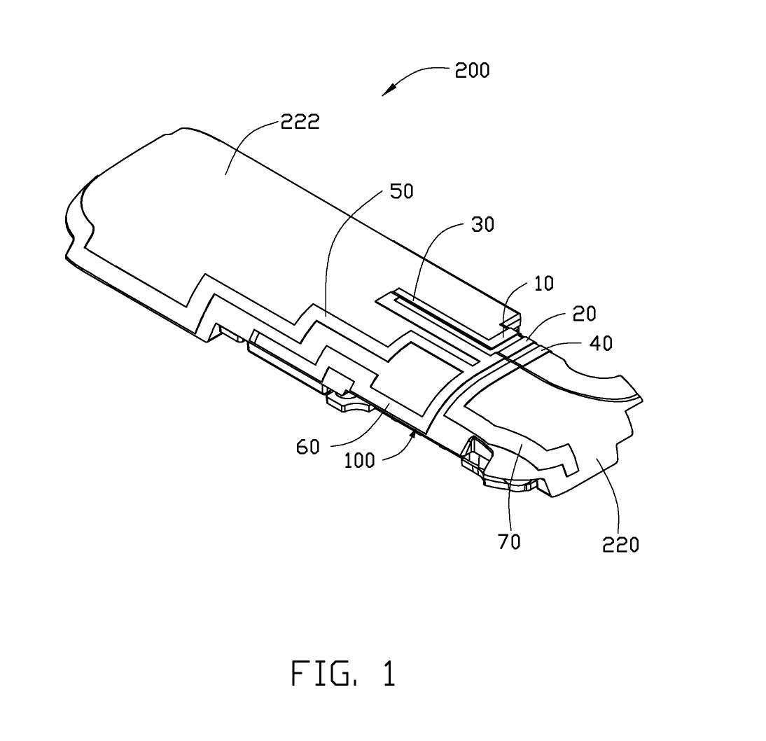

FIG. 1 is a schematic view of an antenna module 100, according to an exemplary embodiment of the disclosure. The antenna module 100 is used in a wireless communication device 200, such as a mobile phone.

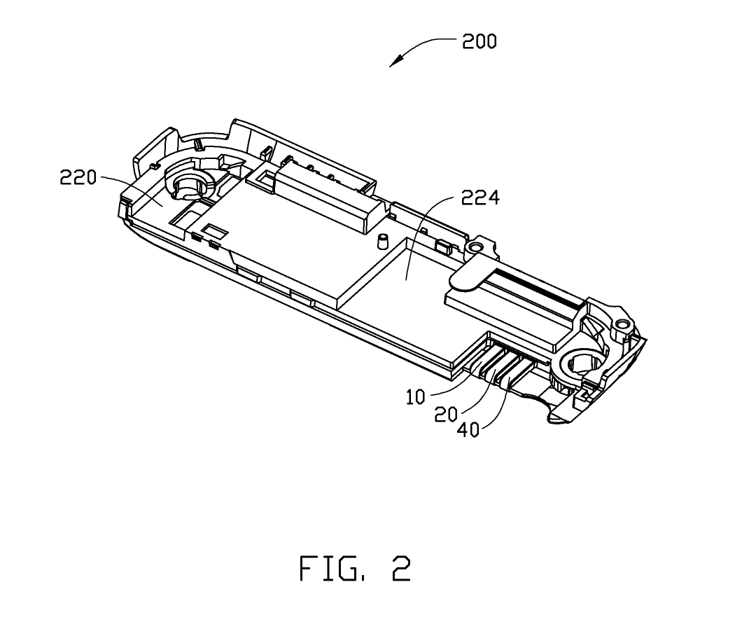

Also referring to FIG. 2, the wireless communication device 200 includes a housing 220. The housing 220 is made of non-conductive material, such as plastic. The housing 220 includes a first surface 222 and a second surface 224 opposite to the first surface 222.

The antenna module 100 includes a first ground portion 10, a feed portion 20, a connecting portion 30, a second ground portion 40, a first radiating portion 50, a second radiating portion 60, and an extending portion 70.

The first ground portion 10, the feed portion 20, and the second ground portion 40 are substantially U-shaped. The first ground portion 10, the feed portion 20, and the second ground portion 40 are attached to the first surface 222 and extend to the second surface 224. The first ground portion 10, the feed portion 20, and the second ground portion 40 are substantially parallel to and spaced from each other. The first ground portion 10 is configured to ground the antenna module 100. The feed portion 20 is configured to feed current to the first radiating body 50 and the second radiating body 60. The feed portion 20 may be a microstrip line or a coaxial cable.

The connecting portion 30 is substantially U-shaped and is attached to the first surface 222. A first end of the connecting portion 30 is connected substantially perpendicularly to the first ground portion 10. A second end of the connecting portion 30 is connected perpendicularly to the feed portion 20, the first radiating body 50, and the second radiating body 60. The connecting portion 30 is a metal sheet, but can be made of other materials in other embodiments. The connecting portion 30 is configured to connect the first radiating body 50 and the second radiating body 60 to the first ground portion 10. In addition, impedance matching of the first radiating body 50 and the second radiating body 60 can be achieved by adjusting dimensions of the connecting portion 30.

The first radiating body 50 is substantially step-shaped and is attached to the first surface 222. A first end of the first radiating body 50 is perpendicularly connected to the feed portion 20 and is also connected to the ground portion 10 via the connecting portion 30. A second end of the first radiating body 50 extends along a first step-shaped path from the connecting portion 30 to an edge of the housing 220 opposite to the feed portion 20. In one exemplary embodiment, the first radiating body 50 includes three steps. The first radiating body 50 transmits and receives signals within a first working frequency band. In this exemplary embodiment, the first frequency band is a low frequency band from about 824 MHz to about 894 MHz.

The second radiating body 60 is also substantially step-shaped and is attached to the first surface 222. A first end of the second radiating body 60 is connected to the feed portion 20. A second end of the second radiating body 60 extends along a second step-shaped path from the feed portion 20 to the edge of the housing 220 opposite to the feed portion 20. The second radiating body 60 is spaced from the first radiating body 50.

The second radiating body 60 transmits and receives signals within a second working frequency band. In this exemplary embodiment, the second frequency band is a high frequency band from about 1710 MHz to about 2170 MHz.

The extending portion 70 is substantially L-shaped and is attached to the first surface 222. A first end of the extending portion 70 is connected to the second ground portion 40. A second end of the extending portion 70 extends from the second ground portion 40 to a side surface of the housing 220. A first end of the extending portion 70 is parallel to and spaced from the feed portion 20. A width between the first end of the extending portion 70 and the feed portion 20 can be changed to adjust a bandwidth of the working frequency band of the second radiating body 60.

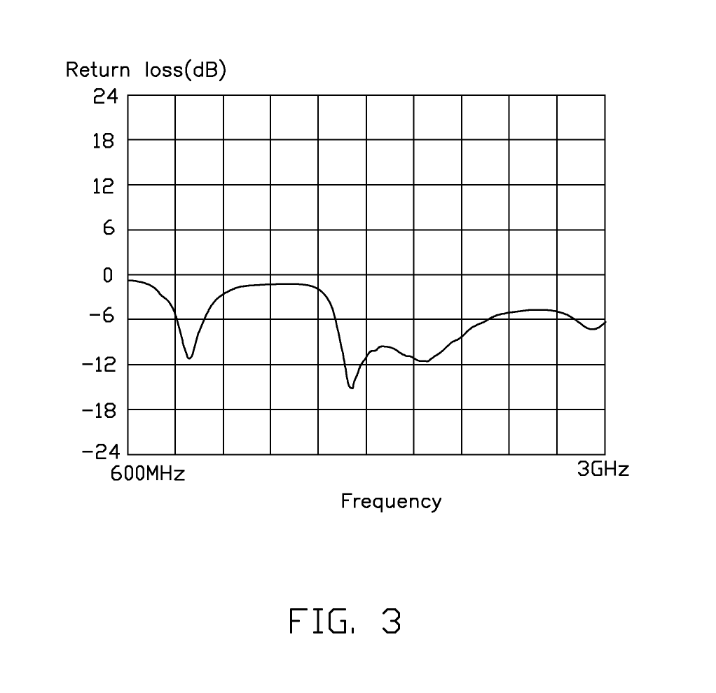

The structures of the first radiating body 50, the second radiating body 60, and the extending portion 70 can be changed according to different requirements. The antenna module 100 can obtain working frequency bands of GSM850/900, DCS, PCS and WCDMA band 1/2/4/5/8. Referring to FIG. 3, in this embodiment, the antenna module 100 operates efficiently within the first working frequency band (824 MHz-894 MHz) and within the second working frequency band (1710 MHz-2170 MHz) and has a relatively wider bandwidth.

The antenna module 100 transmits and receives signals within the first working frequency band and the second working frequency band via the first radiating body 50 and the second radiating body 60, respectively, and also covers multiple frequency bands via the feed portion 20, the second ground portion 40, and the extending portion 70. Additionally, the extending portion 70 is capable of widening the bandwidth of the second working frequency band.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An antenna module for a wireless communication device, the antenna module comprising:
a first ground portion for grounding the antenna module;
a feed portion;
a connecting portion connected to the first ground portion and the feed portion;
a first radiating body connected to the feed portion and the connecting portion, the first radiating body obtaining a first working frequency band;
a second radiating body connected to the feed portion and the first radiating body, the second radiating body obtaining a second working frequency band;
a second ground portion, the second ground portion, the feed portion, and the first ground portion parallel to and spaced from each other; and
an extending portion connected to the second ground portion and spaced from the feed portion, the extending portion configured for adjusting a bandwidth of a preset frequency band of the antenna module.

2. The antenna module of claim 1, wherein the housing comprises a first surface and a second surface opposite to the first surface, the first ground portion, the feed portion and the second ground portion are substantially U-shaped, the first ground portion, the feed portion and the second ground portion are attached to the first surface and extend from the first surface to the second surface.

3. The antenna module of claim 1, wherein the connecting portion is substantially U-shaped, a first end of the connecting portion is perpendicularly connected to the first ground portion, a second end of the connecting portion is perpendicularly connected to the feed portion, the first radiating portion, and the second radiating portion, the connecting portion is capable of adjusting a matching resistance of the first radiating body and the second radiating body by changing dimensions of the connecting portion.

4. The antenna module of claim 1, wherein the first radiating portion is substantially step-shaped, a first end of the first radiating body is perpendicularly connected to the feed portion, a second end of the first radiating body extends from the connecting portion to an edge of the housing opposite to the feed portion along a first step-shaped path.

5. The antenna module of claim 4, wherein the second radiating portion is substantially step-shaped, a first end of the second radiating body is perpendicularly connected to the feed portion, a second end of the second radiating body extends from the feed portion to an edge of the housing opposite to the feed portion along a second step-shaped path, the second radiating body is spaced from the first radiating body and parallel to each other.

6. The antenna module of claim 1, wherein the extending portion is substantially L-shaped, a first end of the extending portion is connected to the second ground portion, a second end of the extending portion extends from the second ground portion to a side surface of the housing, a first end of the extending portion is parallel to and spaced from the feed portion.

7. A wireless communication device, comprising:
a housing; and
an antenna attached to the housing, the antenna module comprising:
a first ground portion for grounding the antenna module;
a feed portion;
a connecting portion connected to the first ground portion and the feed portion;
a first radiating body, the first radiating body connected to the feed portion and the connecting portion, the first radiating body obtain a first working frequency band;
a second radiating body connected to the feed portion and the first radiating body, the second radiating body obtaining a second working frequency band;
a second ground portion, the second ground portion, the feed portion, and the first ground portion parallel to and spaced from each other;
an extending portion connected to the second ground portion and spaced from the feed portion, the extending portion configured to adjust a bandwidth of a preset frequency band of the antenna module.

8. The wireless communication device of claim 7, wherein the housing comprises a first surface and a second surface opposite to the first surface, the first ground portion, the feed portion and the second ground portion are substantially U-shaped, the first ground portion, the feed portion and the second ground portion are attached to the first surface and extended from the first surface to the second surface.

9. The wireless communication device of claim 7, wherein the connecting portion is substantially U-shaped, a first end of the connecting portion is perpendicularly connected to the first ground portion, a second end of the connecting portion is perpendicularly connected to the feed portion, the first radiating portion, and the second radiating portion, the connecting portion is capable of adjusting a matching resistance of the first radiating body and the second radiating body by changing dimensions of the connecting portion.

10. The wireless communication device of claim 7, wherein the first radiating portion is substantially step-shaped, a first end of the first radiating body is perpendicularly Page 10 of 12 connected to the feed portion, a second end of the first radiating body extends from the connecting portion to an edge of the housing opposite to the feed portion along a first step-shaped path.

11. The wireless communication device of claim 10, wherein the second radiating portion is substantially step-shaped, a first end of the second radiating body is perpendicularly connected to the feed portion, a second end of the second radiating body extends from the feed portion to an edge of the housing opposite to the feed portion along a second step-shaped path, the second radiating body is spaced from the first radiating body and parallel to each other.

12. The wireless communication device of claim 7, wherein the extending portion is substantially L-shaped, a first end of the extending portion is connected to the second ground portion, a second end of the extending portion extends from the second ground portion to a side surface of the housing, a first end of the extending portion is parallel to and spaced from the feed portion.
